(19) United States
(12) Patent Application Publication
(10) Pub. No.: US 2002/0020720 A1
(43) Pub. Date: Feb. 21, 2002

(54) Device for storing and dispensing a liquid, viscous or pasty medium

(76) Inventors: Dieter Schmid, Riederau (DE); Oliver Schmid, Munster (DE)

Correspondence Address: LERNER AND GREENBERG, P.A., POST OFFICE BOX 2480, HOLLYWOOD, FL, 33022-2480, US

(21) Appl. No.: 09/878,883

(22) Filed: Jun. 11, 2001

Related U.S. Application Data
(63) Continuation of application No. PCT/DE99/03969, filed on Dec. 7, 1999.

(30) Foreign Application Priority Data
Dec. 9, 1998 (DE) 198 56 719.7

(51) Int. Cl. B67D 5/40

(52) U.S. Cl. 222/383.1; 222/482

(57) ABSTRACT

A device for storing and dispensing a medium includes a container for storing a medium to be dispensed and a dispensing device which is connected to the container and serves to vaporize, spray or pump the medium stored in the container. The dispensing device is provided with a filling opening through which the container can be filled with the medium to be dispensed by the dispensing device. The dispensing device is configured in such a way that a medium filled into the filling opening passes through the dispensing device. The filling opening, through which the container can be filled with the medium to be dispensed by the dispensing device, is inclined with respect to the horizontal when the device is in a vertical position. In this way the container can be filled simply, rapidly and cleanly.

### CROSS-REFERENCE TO RELATED APPLICATION

This application is a continuation of copending International Application No. PCT/DE99/03969, filed Dec. 7, 1999, which designated the United States.

### BACKGROUND OF THE INVENTION

1. Field of the Invention

The invention relates to a device for storing and dispensing a liquid, viscous or pasty medium, having a container for storing the medium which is to be dispensed, and having a dispensing device which is connected to the container and is intended for spraying, sprinkling or pumping out the medium contained in the container.

Devices of this type are, for example, but not limited to spraying bottles for spraying plants with water or for spraying objects which are to be cleaned, such as windows, tiles etc., with cleaning materials. Certain cleaning materials, for example window cleaning materials, are frequently sold already in spraying bottles of this type.

As is known, spraying bottles of this type include a liquid container for holding the liquid which is to be sprayed and a spraying head for spraying the liquid which is contained in the liquid container. Through the use of the spraying head the liquid contained in the liquid container can be applied (sprayed) in a targeted manner and metered in accordance with given requirements onto the objects which are to be sprayed.

The liquid containers of spraying bottles of this type have an opening via which the liquid which is to be sprayed by the spraying head is transported from the liquid container to the spraying head. This opening serves also as a liquid-filling opening for filling the liquid container with liquid.

When the spraying bottle is assembled, the opening of the liquid container is closed by the spraying head. The spraying head is placed over the liquid-container opening and therefore serves not only for spraying the liquid which is to be sprayed, but at the same time for closing the liquid-filling opening of the spraying bottle.

Nonetheless, the filling of the liquid container is a relatively simple process. In order to make the liquid-filling opening accessible, one only has to remove (unscrew) the spraying head from the spraying bottle.

When removing, temporarily putting down and re-fitting the spraying head, the person occupied therewith and objects which are situated in the surroundings may come into contact with the liquid that is already in the liquid container. The fact that the liquid runs or drips out of the spraying head and/or out of a suction line running from the latter into the liquid container has up to now been unavoidable in practice.

The amount of liquid running or dripping out of the spraying head is relatively small and generally not a problem.

However, there are cases in which even such small quantities of liquid may cause a serious problem. For example, this is the case when poisonous or corrosive liquids are being worked with, i.e. when, for example, a spraying bottle configured for spraying plants is used to spray pesticides. Any contact with liquids of this type should be avoided if possible because of the health risk resulting therefrom.

The same may apply—even if not to the extent mentioned and for the reasons mentioned—also for other devices for storing and dispensing a liquid, viscous and pasty medium, for example soap dispensers etc.

### SUMMARY OF THE INVENTION

It is accordingly an object of the invention to provide a device for storing and dispensing a liquid, viscous or pasty medium which overcomes the above-mentioned disadvantages of the heretofore-known devices of this general type and which allows to fill the device with a medium, which is to be dispensed by the device, in such a manner that neither the person occupied therewith nor objects in the surroundings come into contact with the medium in the container and which does not require substantial changes when starting out with the conventional devices.

With the foregoing and other objects in view there is provided, in accordance with the invention, a device for storing and dispensing a medium, including:

a container for storing a liquid medium, a viscous medium or a pasty medium to be dispensed, the container having a container opening formed therein;

a dispensing device, connected to the container, for spraying, sprinkling or pumping out the medium stored in the container;

the dispensing device having a filling opening formed therein for filling the container with the medium to be dispensed by the dispensing device;

the container being configured such that the medium to be dispensed by the dispensing device is transported from the container to the dispensing device via the container opening; and

a laterally closed channel extending from the filling opening to the container, the laterally closed channel being configured such that the medium to be poured into the filling opening passes through the dispensing device via the laterally closed channel and passes into the container via the container opening.

In other words, the device according to the invention is distinguished in that the dispensing device is provided with a filling opening via which the container can be filled with the medium which is to be dispensed by the dispensing device, and in that the dispensing device is configured in such a manner that a medium which is poured into the filling opening runs through the dispensing device and passes into the container via a container opening via which the medium which is to be dispensed by the dispensing device is also transported from the container to the dispensing device.

With the objects of the invention in view there is also provided, a device for storing and dispensing a medium, including:

a dispensing configuration including a container for storing a liquid medium, a viscous medium or a pasty medium, and a dispensing device for dispensing the medium by spraying, sprinkling or pumping out the medium stored in the container;

the dispensing configuration having a filling opening formed therein for filling the container with the medium to be dispensed by the dispensing device; and

the filling opening being inclined with respect to a horizontal plane when the dispensing configuration is in an upright standing position, the filling opening is inclined with respect to the horizontal plane in such a way that the container can be filled via the filling opening even when the dispensing configuration is substantially in a horizontal lying position.

In other words, the device according to the invention is distinguished in that when the device is standing upright the filling opening, via which the container can be filled with the medium which is to be dispensed by the dispensing device, is provided inclined with respect to the horizontal plane.

According to another feature of the invention, the filling opening is inclined with respect to a horizontal plane when the container is in an upright standing position, and the filling opening is inclined with respect to the horizontal plane in such a way that the container can be filled via the filling opening even when the container is in a substantially horizontal lying position.

The device may also be filled when it is in its assembled state by providing the filling opening on the dispensing device. The dispensing device no longer has to be removed from the container in order to fill the device with medium which is to be dispensed by the device, and as a result neither people nor objects can come into contact with the medium in the container before, during or after the filling.

The inclined configuration of the filling opening makes it possible for the device not only to be filled when standing upright, but also when the device is inclined to a greater or lesser extent, and under some circumstances even when the device is in a horizontal position. The device can therefore be filled simply, rapidly and cleanly without any problems, even in confined conditions, for example in small washbasins.

The fact that the container opening, via which a medium, which is poured into the filling opening, passes into the container, is at the same time the container opening, via which the medium, which is to be dispensed by the dispensing device, is also transported from the container to the dispensing device, makes it possible for the container—although it is to be filled in a different manner than previously—as before, just to have a single opening and therefore can also be constructed in an extremely simple manner. Furthermore, the containers of conventional devices for storing and dispensing a liquid, viscous or pasty medium can be used as containers for the new type of device.

According to another feature of the invention, the dispensing device includes a mechanism; and the dispensing device is configured such that the medium to be poured in via the filling opening cannot come into contact with the mechanism. According to yet another feature of the invention, a lid is placed over the filling opening for closing the filling opening. The lid is preferably fastened to the dispensing device or the container.

According to yet another feature of the invention, the dispensing device is a detachable unit attached to the container.

According to yet another feature of the invention, the filling opening is disposed in an upper region of the dispensing configuration.

According to a further feature of the invention, the filling opening is formed in the dispensing device.

According to yet a further feature of the invention, a laterally closed channel extends from the filling opening to the container, the laterally closed channel is configured such that the medium to be poured into the filling opening passes through the dispensing device via the laterally closed channel.

According to another feature of the invention, the dispensing device includes a mechanism; and the dispensing device is configured such that the medium to be poured in via the filling opening cannot come into contact with the mechanism.

According to a further feature of the invention, a lid is placed over the filling opening for closing the filling opening. The lid is preferably fastened to the dispensing configuration.

According to another feature of the invention, the dispensing device is a detachable unit which is placed or mounted on the container.

Other features which are considered as characteristic for the invention are set forth in the appended claims.

Although the invention is illustrated and described herein as embodied in a device for storing and dispensing a liquid, viscous or pasty medium, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic perspective view of a spraying device according to the invention; and

FIG. 2 is a diagrammatic bottom plan view of the spraying head of the spraying device according to FIG. 1.

### DESCRIPTION OF THE PREFERRED EMBODIMENTS

Referring now to the figures of the drawings, the device for storing and dispensing a liquid, viscous or pasty medium, in this case a spraying device for spraying liquid, is described in detail. However, it is noted that the particular characteristics of the spraying device which are described in greater detail below can also be provided for any other devices for storing and dispensing a liquid, viscous or pasty medium. The devices in which the particular characteristics which are described in greater detail below can be provided include, in addition to the spraying devices which have already been mentioned, in particular (but in no way exclusively) dispensers for liquid soap, perfume, oils, lotions, disinfectants and many other things, and other devices which spray, sprinkle or pump out substances contained in a container. One example of a device of this type is described in German Published, Non-Prosecuted Patent Application DE 197 46 101 A1.

The spraying device which is described in greater detail below is configured such that is can be used as a spraying bottle for spraying plants. However, it is pointed out that spraying devices of the described type can also be used for any other desired purposes—if appropriate after suitable adaptation to the particular intended use.

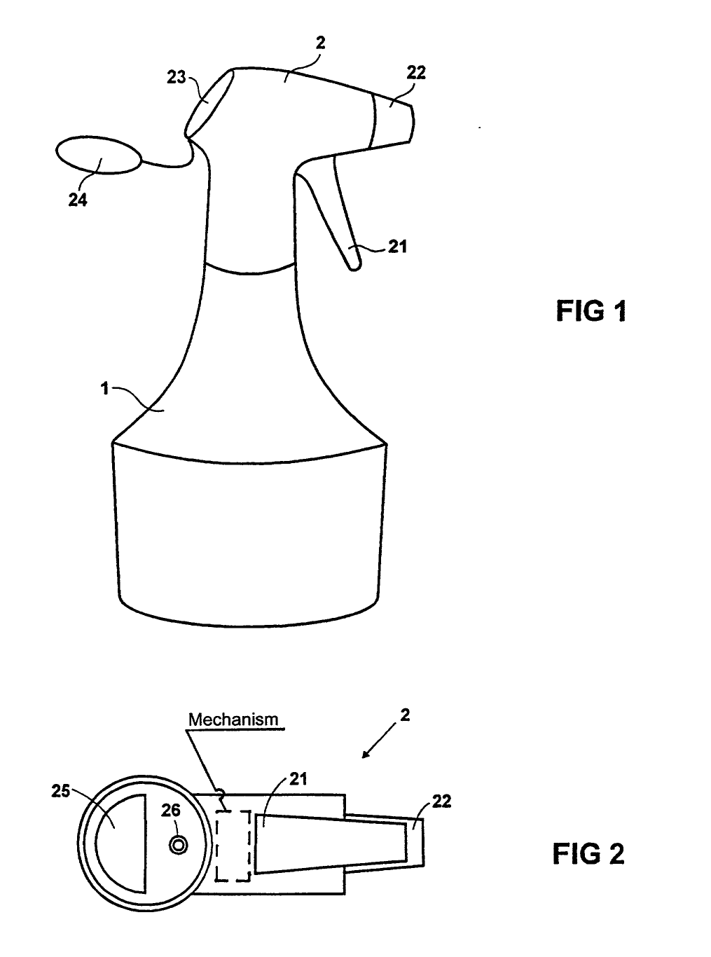

As can be seen in particular from FIG. 1, the spraying device which is considered in the present case includes a (liquid) container 1 and a (liquid-) dispensing device in the form of a spraying head 2, where the spraying head 2 can be placed or mounted onto the liquid container 1.

The spraying head 2 can be placed onto the liquid container 1 by screwing, latching, plugging together or in another manner. The connection between the spraying head 2 and liquid container 1 is preferably liquid-tight, so that it is not possible for any liquid to pass to the outside from the interior of the spraying device at the connecting location.

The spraying head 2 is connected to the liquid container 1 preferably in a releasable or detachable manner. In the example under consideration this is not absolutely necessary, because, as will be explained in greater detail below, the spraying head 2 no longer has to be removed in order to pour in liquid which is to be sprayed. However, it is advantageous when the spraying head 2 is connected to the liquid container 1 in a releasable or detachable manner, in particular for the purpose of cleaning, maintenance and repair of the spraying device.

In the example considered here, the liquid container 1 is a bottle-like structure, however, the liquid container may also have any other desired shape. Irrespective of the shape, at the location where the spraying head 2 is connected to the liquid container 1, the liquid container has an opening (completely covered by the spraying head when the spraying head is placed onto the liquid container).

The spraying head 2 includes a mechanism, which is only schematically indicated in FIG. 2 with a box outlined with a broken line, through the use of which liquid in the liquid container 1 is sucked up, on actuation of a lever 21, via a suction line (not shown) and sprayed via a nozzle 22. To this extent, the spraying head 2 which is shown corresponds with conventional spraying heads. In contrast to conventional spraying heads, the spraying head 2 also has a liquid-filling opening 23 and a lid 24 which is provided for closing the latter.

At present, it is regarded as optimum if the liquid-filling opening 23 and the lid 24 are provided on the spraying head 2. Nonetheless, it is not absolutely necessary for the liquid-filling opening 23 and/or the lid 24 to be provided on the spraying head 2. The liquid-filling opening 23 and/or the lid 24 may in principle also be provided in or on the liquid container 1 or on another component of the spraying device. For example, the liquid-filling opening could be the opening of a filling neck issuing from the liquid container 1.

As the designation already indicates, the liquid-filling opening 23 can be used for pouring into the spraying device liquids which are to be sprayed; liquids poured in via the liquid-filling opening 23 pass via the spraying head 2 and the liquid-container opening (already mentioned above) into the liquid container 1 and collect there.

In the example considered here, the liquid-container opening, via which a liquid which is poured into the liquid-filling opening 23 passes into the liquid container 1, is the liquid-container opening, via which the liquid which is to be sprayed by the spraying head is also transported from the liquid container to the spraying head. This fact makes it possible for the liquid container—although it is to be filled in a different manner than has been done before with the conventional devices—as before, to have just a single opening and the liquid container can therefore also be constructed in an extremely simple manner, and furthermore the liquid containers of conventional spraying bottles can be used as containers for the new type of device.

The liquid poured in via the liquid-filling opening 23 is preferably conducted to the liquid container 1 in such a manner that it does not come into contact in other words cannot come into contact with the mechanism provided in the spraying head 2. This makes it possible to prevent the mechanism from being dirtied and/or damaged by the liquid which is poured in.

In the example under consideration, this is achieved by the fact that the liquid which is poured in via the liquid-filling opening 23 is conducted through the spraying head 2 via a laterally closed channel 25.

In the example considered here, this channel 25 is approximately half the size of the liquid-container opening via which the liquid container 1 can be filled and emptied. Via the remaining part of the liquid-container opening, which part is not taken up by the channel 25, the liquid which is to be sprayed by the spraying head 2 can be transported from the liquid container to the spraying head. In the example under consideration, this takes place through the use of the suction line which has already been mentioned, but is not shown in the figures, which can be placed onto a nipple 26 of the spraying head and extends from there via the liquid-container opening into the liquid container (preferably as far as the bottom thereof).

The liquid-filling opening 23 is preferably located in the upper region of the spraying device (of the spraying head 2) in a sloping or inclined section thereof. In the example under consideration, the angle of inclination of this spraying-device section with respect to the horizontal plane is approximately 45°, but may also be much larger or smaller as desired. Since the liquid-filling opening 23 extends both in the horizontal and vertical direction, the liquid which is to be poured in via the liquid-filling opening can be poured in both from above and from the side or—in other words—both when the spraying bottle is upright and when it is inclined (as far as being horizontal). The latter state proves to be very advantageous because the spraying bottle can then be filled with water without any problem even when there is only a very small washbasin available, which could be a problem in the case of spraying bottles which can be filled only in an upright position. It should be clear that the liquid-filling opening can in principle also be provided at any other desired points on the spraying head and can also be orientated in a different way.

In the example under consideration, the liquid-filling opening 23 is of approximately semicircular shape and has a relatively large diameter. Of course, form and size of the liquid-filling opening can be varied as desired.

In the example under consideration, the lid 24 (only illustrated schematically in the figure) is configured to latch to the spraying head 2 when placed correctly over the liquid-filling opening 23. However, any other desired closure mechanisms (screw-type closure, bayonet-type closure, snap-type closure etc.) may also be used.

The lid 24 is preferably fastened to the spraying head 2. As a result, after it has been removed from the liquid-filling opening 24 it does not have to be put down and also cannot be lost or forgotten.

Under some circumstances, the lid 24 could even be dispensed with, since if and as long as the spraying bottle is not inclined too severely, which is always the case when the spraying bottle is handled correctly, liquid cannot discharge or spill out of the liquid-filling opening 23 which is provided at the upper end of the spraying bottle.

However, it is recommended to provide a lid, in particular when the spraying bottle is used or can be used to spray vaporizing and/or poisonous and/or corrosive liquids.

In such a case, the spraying bottle is filled with liquid to be sprayed in three steps, namely:

step 1: opening the lid 24,

step 2: pouring in the liquid to be poured in via the liquid-filling opening 23, and

step 3: closing the lid 24.

In none of the three steps does the person doing the pouring-in and/or do objects in the vicinity of the pouring-in location come into contact with the liquid already in the spraying bottle or to be poured into the spraying bottle, because:

the lid 24 is always dry because the opening, which is to be closed with it, is always provided at the upper end of the spraying bottle, and also the lid does not at any point have to be put down anywhere, and

the liquid-filling opening can be configured and provided irrespective of the rest of the configuration of the spraying device in such a manner that spillage of liquid to be poured in is ruled out under normal circumstances.

Of course, the liquid which is to be sprayed by the spraying device may also be a liquid mixture including a plurality of liquids. In this case, the liquids which are to be mixed can be poured in at the same time or successively and from essentially any desired vessels or pipes. The fact that liquids which are to be poured in, in the case of the spraying device under consideration, can be poured in from essentially any desired vessels or pipes also applies, of course, for liquids which are not to be mixed.

Liquid-soluble tablets, powders etc. may also be poured in in a very simple and reliable manner and without spillage via the liquid-filling opening.

Spraying devices of the type described above have therefore proven extremely advantageous despite the changes being only relatively slight: they can be filled simply, rapidly and cleanly under all circumstances and make it possible as a result to use even poisonous and/or corrosive liquids without a problem.

We claim:

1. A device for storing and dispensing a medium, comprising:
a container for storing a medium selected from the group consisting of a liquid medium, a viscous medium and a pasty medium to be dispensed, said container having a container opening formed therein;
a dispensing device, connected to said container, for one of spraying, sprinkling and pumping out the medium stored in said container;
said dispensing device having a filling opening formed therein for filling said container with the medium to be dispensed by said dispensing device;
said container being configured such that the medium to be dispensed by said dispensing device is transported from said container to said dispensing device via said container opening; and
a laterally closed channel extending from said filling opening to said container, said laterally closed channel being configured such that the medium to be poured into said filling opening passes through said dispensing device via said laterally closed channel and passes into said container via said container opening.

2. The device according to claim 1, wherein said filling opening is inclined with respect to a horizontal plane when said container is in an upright standing position, and said filling opening is inclined with respect to the horizontal plane in such a way that said container can be filled via said filling opening even when said container is in a substantially horizontal lying position.

3. The device according to claim 1, wherein:
said dispensing device includes a mechanism; and
said dispensing device is configured such that the medium to be poured in via said filling opening cannot come into contact with said mechanism.

4. The device according to claim 1, including a lid to be placed over said filling opening for closing said filling opening.

5. The device according to claim 4, wherein said lid is fastened to one of said dispensing device and said container.

6. The device according to claim 1, wherein said dispensing device is a detachable unit placed on said container.

7. A device for storing and dispensing a medium, comprising:
a dispensing configuration including a container for storing a medium selected from the group consisting of a liquid medium, a viscous medium and a pasty medium, and a dispensing device for dispensing the medium by one of spraying, sprinkling and pumping out the medium stored in said container;
said dispensing configuration having a filling opening formed therein for filling said container with the medium to be dispensed by said dispensing device; and
said filling opening being inclined with respect to a horizontal plane when said dispensing configuration is in an upright standing position, said filling opening is inclined with respect to the horizontal plane in such a way that said container can be filled via said filling opening even when said dispensing configuration is substantially in a horizontal lying position.

8. The device according to claim 7, wherein said dispensing configuration has an upper region and said filling opening is disposed in said upper region.

9. The device according to claim 7, wherein said filling opening is formed in said dispensing device.

10. The device according to claim 7, including a laterally closed channel extending from said filling opening to said container, said laterally closed channel being configured such that the medium to be poured into said filling opening passes through said dispensing device via said laterally closed channel.

11. The device according to claim 7, wherein:
said dispensing device includes a mechanism; and
said dispensing device is configured such that the medium to be poured in via said filling opening cannot come into contact with said mechanism.

12. The device according to claim 7, including a lid to be placed over said filling opening for closing said filling opening.

13. The device according to claim 12, wherein said lid is fastened to said dispensing configuration.

14. The device according to claim 7, wherein said dispensing device is a detachable unit placed on said container.
